(19) United States
(12) Patent Application Publication
(10) Pub. No.: US 2009/0280367 A1
(43) Pub. Date: Nov. 12, 2009

(54) Extraction of Energy From Used Cooking Oil

(75) Inventors: Jon Slangerup, Bel-Air, CA (US); Brett Vinsant, Tigard, OR (US); Bill Sproull, North Plains, OR (US); Zakiul Kabir, Hillsboro, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: CLEAREDGE POWER, INC., Hillsboro, OR (US)

(21) Appl. No.: 12/118,995

(22) Filed: May 12, 2008

(51) Int. Cl. H01M 8/06

(52) U.S. Cl. 429/19; 429/17

(57) ABSTRACT

The extraction of energy from used cooking oil is disclosed. In one embodiment, used cooking oil is admitted from a cooking appliance to an interface, and then to a reactor or a series of reactors where it is reformed into a hydrogen-containing, reformed fuel. The hydrogen-containing, reformed fuel is then admitted to a fuel cell which produces electricity.

### BACKGROUND

Preparation of fried foods is an energy-intensive activity. In restaurants and other food-preparation facilities, significant energy is supplied to the fry bath each business day: heat energy to maintain the temperature of the hot oil and the caloric energy of the oil itself. At the present time, there is significant interest in recycling used cooking oil to harvest its energy content. Some strategies involve transporting the oil from the food preparation facility to a biodiesel plant, where it is converted to a mixture of esterified fatty acids (biodiesel).

While such strategies may result in the recovery of significant energy content from used cooking oil, their economic and energy-based efficiencies may be limited by transport-related losses. Losses may result from the transport of used cooking oil from the food preparation facility to the biodiesel plant as well as transport of the biodiesel product from the plant to the fueling station. Furthermore, the transport and distribution infrastructures associated with these strategies may involve significant labor costs, energy costs and capital outlay.

### SUMMARY

Therefore, the processing of used cooking oil to extract energy therefrom is disclosed herein. In one disclosed embodiment, used cooking oil at a food-preparation facility may be admitted to an interface configured to admit used cooking oil from a cooking appliance, and then to a reactor or a series of reactors where it is reformed into a hydrogen-containing, reformed fuel. The hydrogen-containing, reformed fuel is then admitted to the anode of a fuel cell. Supplied in this way with a fuel derived from used cooking oil, the fuel cell may produce electricity for use, for example, within the food-preparation facility.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a used cooking oil processing system according to the present disclosure.

FIG. 2 shows, by way of a flow chart, an embodiment of a method to derive electrical energy from used cooking oil according to the present disclosure.

### DETAILED DESCRIPTION

The present disclosure is directed to the extraction of energy from used cooking oil at the site at which the used cooking oil is generated and thereby helps to avoid transport-related loss in energy recovery. The embodiments described herein may be appropriate for use at a restaurant or other food-preparation facility that uses suitable amounts of cooking oil.

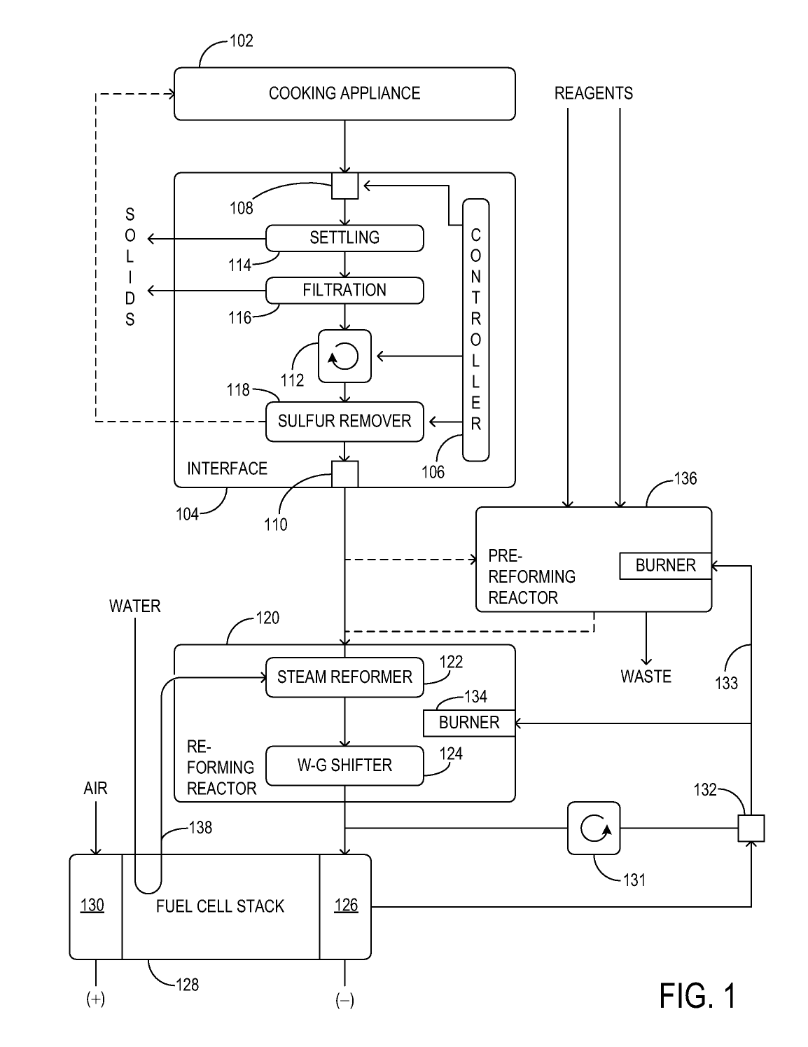

FIG. 1 shows an embodiment of a used cooking oil processing system according to the present disclosure. In particular, FIG. 1 shows cooking appliance 102 and interface 104, the cooking appliance disposed upstream of and in fluidic communication with the interface. Cooking appliance 102 may include a fry bath. Interface 104 is configured to admit used cooking oil from the cooking appliance and to release it for further processing. In this example, interface 104 further comprises controller 106, first valve 108, second valve 110, and recirculation pump 112. Controller 106 controls an admission of the used cooking oil to the interface and a release of the used cooking oil from the interface; it may be configured to open and close the first and second valves and to engage and disengage the recirculation pump.

In this example, interface 104 also includes settling tank 114 and filtration unit 116, which are configured to reduce the amount of solids in the used cooking oil. Interface 104 also includes sulfur remover 118, which is configured to reduce the amount of sulfur in the used cooking oil by removing some sulfur-containing chemical species therefrom.

Settling tank 114 may be configured to remove relatively large particles from the admitted used cooking oil, while filtration unit 116 may remove smaller particles. In some examples, filtration unit 116 may include a filter or series of filters. Sulfur remover 118 may include an adsorbent material that has a high affinity for the particular sulfur-containing chemical species commonly found in used cooking oil, which may include proteins and sulfoxides. Exemplary adsorbent materials in accordance with this disclosure include silica, alumina, and activated carbon. In other embodiments, sulfur remover 118 may include a microfluidic hydrodesulfurization unit comprising a catalyst. Exemplary hydrodesulfurization catalysts may be cobalt- or molybdenum-based, but other catalysts are contemplated as well. In some circumstances, hydrodesulfurization may offer a relative increased utilization of the cooking-oil and/or lower generation of waste products than adsorption-based sulfur removal.

In some embodiments, controller 106 may be configured to open and close first valve 108 in order to admit specific quantities of used cooking oil to the interface according to a pre-programmed schedule. In some embodiments, recirculation pump 112 may be configured to circulate used cooking oil back to cooking appliance 102. Thus, the cooking oil in cooking appliance 102 may pass through the interface only once or be subject to intermittent solids removal at the interface. Controller 106 may further be configured to release specific quantities of used cooking oil from the interface according to a pre-programmed schedule.

It should be understood that the inclusion of a settling tank, a filtration system, and a sulfur remover in the example interface of FIG. 1 is not intended to be limiting. In other embodiments, one or more of these elements may be absent. In still other embodiments, one or more of these elements may be replaced by other elements, whether functionally similar or functionally distinct. For instance, the settling tank of FIG. 1 could be replaced by a centrifuge. The filtration system could be replaced by a device that uses ultrasound to break up large particles into smaller, more dispersible particles.

In some embodiments, cooking appliance 102 and interface 104 may be physically integrated. They may, for example, share a common enclosure and common electrical feeds. A common, insulative enclosure may be used to maintain filtration unit 116 at an elevated temperature, viz., a temperature between the ambient and that of the hot cooking oil. Maintaining the filtration unit at an elevated temperature may facilitate solids removal by preventing certain fats in the oil from solidifying during filtration. In other embodiments, cooking appliance 102 and interface 104 may be physically separate. In these embodiments, cooking appliance 102 may be connected to interface 104 by a conduit such as a manifold or hose. Such embodiments may allow the used cooking oil processing system to be used with existing cooking systems. In still other embodiments, interface 104 may not be attached to the interface in any physical manner, but instead may be configured to receive used cooking oil that is transferred from the cooking appliance manually, e.g. via containers, and poured into the interface. In any of these embodiments, cooking appliance 102 may communicate with first valve 108 via a drain and a sieve. A sieve may be included to protect first valve 108 from large particles entrained in the oil.

FIG. 1 shows an example reforming reactor 120 disposed downstream of and in fluidic communication with the interface and configured to produce a reformed fuel. In this example, the reforming reactor comprises steam reformer 122 and water-gas shift reactor 124. Steam reformer 122 admits steam and a pre-reformed fuel, in general terms, CₙHₘOₖ. The steam reformer heats the admitted mixture to a temperature at which a reforming reaction, e.g.,

$${C}_{n} {H}_{m} {O}_{k} + ( n - k ) {H}_{2} O -> n CO + ( n + \frac{m}{2} - k ) {H}_{2} ,$$

is spontaneous. The steam reformer contains a supported catalyst of such composition and in such quantity that the rate at which the pre-reformed fuel is reformed is substantially equal to the rate at which it is admitted. Example catalysts and operating conditions for steam reformer 122 are given in TABLE 1.

Water-gas shift reactor 124 may contain one or more water-gas shifting beds operating at different temperatures. In one embodiment, the water-gas shift reactor comprises an adiabatic water-gas shift reactor and an isothermal or actively cooled water-gas shift reactor. However, other water-gas shift reactor system configurations may be used in other embodiments, and may comprise as few as one, or three or more, water-gas shift reactors or sections in one or multiple vessels. Water-gas shift reactor 124 may further be configured to purify the hydrogen-containing effluent according to one or more hydrogen-purifying technologies, which are presently known in the art. Such technologies include, for example, pressure-swing adsorption (PSA).

As shown in FIG. 1, effluent from steam reformer 122 is admitted to water-gas shift reactor 124. Water gas shift reactor 124 admits also steam and is heated to a temperature at which the reaction of a mixture of water and carbon monoxide to yield hydrogen and carbon dioxide, e.g.,

nCO+nH₂O→nCO₂+nH₂,

is spontaneous. Water-gas shift reactor 124 contains a supported catalyst of such composition and in such quantity that the rate at which carbon monoxide reacts is substantially equal to the rate at which it is admitted. Example catalysts and operating conditions for water-gas shift reactor 124 are given in TABLE 1.

FIG. 1 shows fuel cell stack 128 disposed downstream of and in fluidic communication with reforming reactor 120 and configured to receive a reformed fuel therefrom. Specifically, a hydrogen-containing reformed fuel from the reforming reactor is admitted to anodes 126 of the fuel cell stack, while an oxidant such as air is admitted to cathodes 130. FIG. 1 also shows off-gas recirculation pump 131, recirculation control valve 132, and off-gas conduit 133. In this embodiment, anodes 126 release an off-gas containing unspent hydrogen to recirculation control valve 132. Recirculation control valve 132 is configured to deliver off-gas to off-gas recirculation pump 131, which circulates the off-gas back to the anodes. However, recirculation control valve 132 is also configured to intermittently deliver off-gas to burner 134 via off-gas conduit 133. As anode off-gas is purged from the recirculation system, fresh effluent flows to the anodes. In some examples, off-gas conduit 133 may be configured to deliver off-gas to other burners in the system, including a burner of pre-reforming reactor 136.

Fuel cell stack 128 includes cooling conduit 138 configured to admit liquid water and to receive heat from the fuel cell. The fuel cell may be cooled by passage of liquid water through the cooling conduit and/or by evaporation of liquid water within the cooling conduit. In embodiments in which some of the cooling water evaporates, steam is produced within the fuel cell stack. The cooling conduit may be further configured to deliver some of the steam formed by evaporation of cooling water in the fuel cell stack to reforming reactor 120, and particularly to steam reformer 122.

Utilization of steam from evaporation of cooling water is only one example in which heat from the system, that might otherwise be wasted, can instead be used productively according to the present disclosure. In some examples, interface 104 may include an insulative enclosure configured to retard the loss of heat from the used cooking oil. Thus, interface 104 may be configured to release the used cooking oil at an above-ambient temperature and thereby decrease the amount of heat energy required for further processing. In addition, some embodiments may further comprise a heat exchanger (not shown in FIG. 1) which is configured to distribute heat among the various elements of the system. In some embodiments, heat drawn from the heat exchanger may be used to prevent solidification of certain fats within the used cooking oil.

The system as described above admits of various embodiments depending on the particular pre-reformed fuel admitted to reforming reactor 120. For example, in one series of embodiments, the reforming reactor is configured to receive used cooking oil from interface 104 and to produce a reformed fuel therefrom.

In another series of embodiments, the system further comprises pre-reforming reactor 136. As shown in FIG. 1, pre-reforming reactor 136 is disposed downstream of and in fluidic communication with interface 104. The pre-reforming reactor is configured to receive used cooking oil and certain other reagents and to produce therefrom a pre-reformate, i.e., an effluent suitable for reforming. In one example, pre-reforming reactor 136 is configured to admit water and used cooking oil and is heated to a temperature at which conversion of such a mixture to methane and carbon dioxide, e.g.,

$${C}_{n} {H}_{m} {O}_{k} + ( n - \frac{m}{4} - \frac{k}{2} ) {H}_{2} O -> ( \frac{n}{2} + \frac{m}{8} - \frac{k}{4} ) {CH}_{4} + ( \frac{n}{2} - \frac{m}{8} + \frac{k}{4} ) {CO}_{2} ,$$

is spontaneous. Thus, the pre-reforming reactor in this example is configured to produce a methane-containing pre-reformed fuel. In other examples, the pre-reforming reactor is configured to produce other light hydrocarbons in addition to or instead of methane. Such other light hydrocarbons include ethane, propane, and butane, as examples. In still other examples, pre-reforming reactor 136 is configured to admit certain reagents in addition to used cooking oil and to produce a pre-reformed fuel containing esterified fatty acids (biodiesel). In the series of embodiments in which a pre-reforming reactor is included, reforming reactor 120 is disposed downstream of and in fluidic communication with the pre-reforming reactor. In yet other embodiments, other pre-reforming processes may be employed.

Details concerning steam reformer 122 and water-gas shift reactor 124 in some example embodiments are summarized in the TABLE 1 below, where UVO refers to used vegetable oil, S/C is the ratio of steam-to-carbon by mass, and T/° C. is the temperature in degrees Celsius.

TABLE 1

| | | | | T/ | |
|---|---|---|---|---|---|
| REACTOR ELEMENT | REACTANTS | PRODUCTS | S/C | ° C. | CATALYST |
| steam reformer | WVO, H₂O | CO, H₂ | 4.4:1 | 800 | ^{a} |
| | CH₄, H₂O | CO, H₂ | 2.5-3.5:1 | 750-900 | Ni/Al₂O₃ |
| water-gas shift | CO, H₂O | CO₂, H₂ | | 220-250 | Cu/Zn |
| reactor | | | | | |

^{a}a product of InnovaTek (TM) of Richland, Washington

It should be understood that the embodiment detailed in FIG. 1 is one example approach to convert used cooking oil into a hydrogen-containing fuel, and ultimately into electricity. In other embodiments, one or more of the illustrated components may be replaced by other components, whether functionally similar or functionally distinct. For example, steam reformer 122 may be replaced by, or combined with, other types of reforming reactors, which include autothermal reformers (ATR's), partial oxidation reformers (POX's) and catalytic partial oxidation reformers (CPO's).

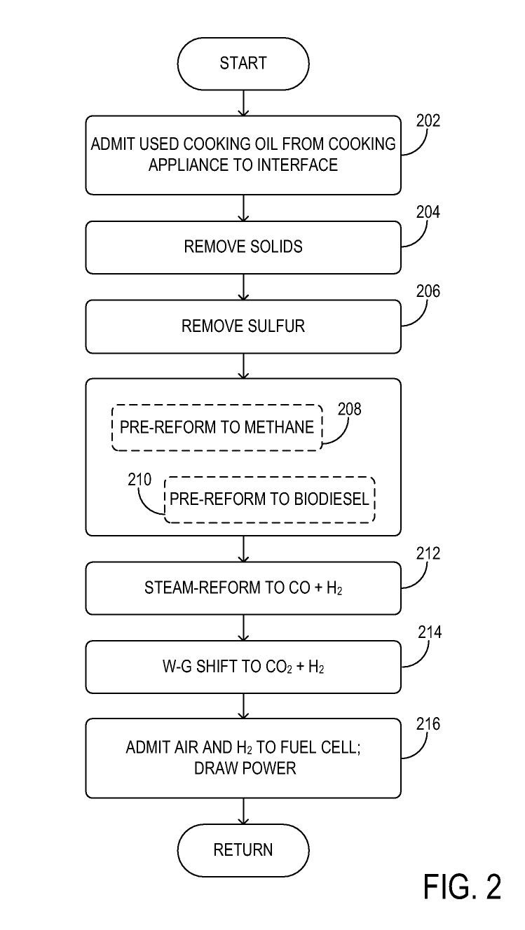

The embodiments disclosed above by example may be utilized in a number of methods to derive electrical energy from used cooking oil. FIG. 2 illustrates one embodiment of such a method 200 by way of a flow chart. In step 202, used cooking oil is admitted from a cooking appliance to an interface. In steps 204 and 206, solids and sulfur, respectively, are removed from the used cooking oil. In one example, the used cooking oil with solids and sulfur removed is reformed by steam reforming (step 212) and water gas shifting (step 214) into a hydrogen-containing reformed fuel. In a second example, the used cooking oil with solids and sulfur removed is pre-reformed (step 208) into a methane-containing pre-reformate. The methane-containing pre-reformate is then reformed by steam reforming (step 212) and water gas shifting (step 214) into a hydrogen containing reformed fuel. In a third example, the used cooking oil with solids and sulfur removed is pre-reformed (step 210) into an esterified fatty-acid containing pre-reformate. The esterified fatty-acid containing pre-reformate is then reformed by steam reforming (step 212) and water gas shifting (step 214) into a hydrogen containing reformed fuel. In yet other embodiments, combinations of these methods may be performed. In a final step 216, the hydrogen-containing reformed fuel is admitted to a fuel-cell anode, an oxidant such as air is admitted to the cathode, and electrical energy is drawn from the fuel cell.

It will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. A system to derive electrical energy from used cooking oil, the system comprising:
an interface configured to admit used cooking oil from a cooking appliance;
a reforming reactor disposed downstream of and in fluidic communication with the interface and configured to produce a reformed fuel; and
a fuel cell disposed downstream of and in fluidic communication with the reforming reactor and configured to receive the reformed fuel therefrom.

2. The system of claim 1, wherein the interface further comprises a first valve, a second valve, and a controller,
wherein the controller is configured to open and close the first valve to control an admission of the used cooking oil, and
wherein the controller is configured to open and close the second valve to control a release of the used cooking oil.

3. The system of claim 1, wherein the interface further comprises a solids remover configured to reduce an amount of solids in the used cooking oil.

4. The system of claim 1, wherein the interface further comprises a sulfur remover configured to reduce an amount of sulfur in the used cooking oil.

5. The system of claim 1, wherein the reforming reactor is configured to receive the used cooking oil and to produce the reformed fuel therefrom.

6. The system of claim 1, further comprising a pre-reforming reactor disposed fluidically between the interface and the reforming reactor, wherein the pre-reforming reactor is configured to receive the used cooking oil and to produce a pre-reformate therefrom.

7. The system of claim 6, wherein the pre-reforming reactor is configured to produce a light hydrocarbon.

8. The system of claim 6, wherein the pre-reforming reactor is configured to produce esterified fatty acids.

9. The system of claim 1, further comprising a first conduit, and wherein the reforming reactor further comprises a burner, the first conduit configured to deliver an off-gas from the fuel cell to the burner.

10. The system of claim 1, further comprising a second conduit configured to admit liquid water, to receive heat from the fuel cell, to produce steam, and to deliver at least some of the steam to the reforming reactor.

11. The system of claim 1, wherein the interface is further configured to release the used cooking oil at an above-ambient temperature.

12. The system of claim 1, further comprising a heat exchanger configured to distribute heat among elements of the system.

13. The system of claim 1, further comprising a cooking appliance disposed upstream of and in fluidic communication with the interface.

14. The system of claim 13, further comprising a pump configured to circulate used cooking oil back to the cooking appliance.

15. A method to derive electrical energy from used cooking oil, the method comprising:
admitting used cooking oil from a cooking appliance to an interface;
reforming the used cooking oil to produce a reformed fuel;
delivering the reformed fuel to a fuel cell; and
drawing electrical energy from the fuel cell.

16. The method of claim 15, further comprising removing at least some solids from the used cooking oil before reforming the used cooking oil.

17. The method of claim 15, further comprising reducing an amount of sulfur in the used cooking oil.

18. A method to derive electrical energy from used cooking oil, the method comprising:
admitting used cooking oil from a cooking appliance to an interface;
removing at least some solids from the used cooking oil;
pre-reforming the used cooking oil to produce a pre-reformate;
reforming the pre-reformate to produce a reformed fuel;
delivering the reformed fuel to a fuel cell; and
drawing electrical energy from the fuel-cell.

19. The method of claim 18, wherein the pre-reformate includes a light hydrocarbon.

20. The method of claim 18, wherein the pre-reformate includes esterified fatty acids.
